(19) United States
(12) Patent Application Publication
(10) Pub. No.: US 2010/0193407 A1
(43) Pub. Date: Aug. 5, 2010

(54) Device and Method For Particle Manipulation in Fluid

(75) Inventors: Victor Steinberg, Rechovot (IL); Vasily Kantsler, Rechovot (IL); Sophie Matlis-Steinberg, Rechovot (IL); Sergey Kapishnikov, Rechovot (IL)

Correspondence Address: MARTIN D. MOYNIHAN d/b/a PRTSI, INC., P.O. BOX 16446, ARLINGTON, VA, 22215, US

(73) Assignee: Yeda Research and Development Co., Ltd., Rechovot (IL)

(21) Appl. No.: 12/087,895

(22) PCT Filed: Jan. 9, 2007
(86) PCT No.: PCT/IL07/00035

§ 371 Date: Jul. 17, 2008

Related U.S. Application Data
(60) Provisional application No. 60/759,954, filed on Jan. 19, 2006.

(51) Int. Cl. B03B 5/62; B01D 21/28; B01D 21/30

(52) U.S. Cl. 209/155; 210/208; 210/748.05; 210/143; 210/137

(57) ABSTRACT

A device for manipulating particles present in a fluid medium is disclosed. The device comprises a planar substrate, formed with at least one primary microchannel to allow passage of the fluid medium therethrough. The primary microchannel(s) has walls and a base and being in fluid communication with a plurality of secondary microchannels via at least one branching point. The device further comprises one or more ultrasound transmission pairs, positioned at opposite sides of the walls to generate ultrasound waves propagating through the fluid medium, substantially parallel to the planar substrate, such as to form a standing wave within the primary microchannel.

### FIELD AND BACKGROUND OF THE INVENTION

The present invention relates to a device and method for manipulating particles in a fluid medium, and more particularly, to a device and method which employ ultrasound waves for separating and/or sorting particles in a fluid medium.

Increasing needs in biotechnology, environmental science and medical applications in continuous flow analysis require filtration of basic fluids from particles and cells that can interfere with the on-line analysis. Such continuous flow to separators and size sorters are also needed in the fast developing field of micro-fluidics.

Known cell separation methods from body fluids operate by means of filtration, centrifugal force or sedimentation. Traditional methods employ sequential steps for freeing liquids from particles (water processing) and removing the liquid thereafter. Such techniques are typically employed in large scale biotechnological processes, water purifications and particle-flow separators. Filtration and size sorting are performed either by centrifuge or by membrane filters that significantly obstruct the continuous flow process. Additionally, in such methods particle recovery from the filters used is not possible.

In advanced small scale biotechnological processes particle and cell manipulation is based on much more sophisticated methods that typically use specific chemical bonding to extract certain constituents with high degree of resolution, purity and effectiveness. Known small scale biotechnological processes for cell separation include density gradient centrifugation, fluorescent activated cell sorting (FACS), magnetic associated cell separation (MACS), and laser capture micro dissection (LCMD).

An alternative approach in particle separation is to exploit physical bulk forces to conduct continuous flow separation and size sorting by using the physical properties of particles. Such approach is advantageous over the above techniques because it facilitates an in-line flow-through separating process with rather low flow resistance.

It is a well known physical phenomenon that when high frequency ultrasonic standing waves is applied on a fluid containing particles, patterns of particles that are denser than the fluid are formed at velocity anti-nodal planes separated by a half a wavelength. These patterns are known as “Kundt figures”, after August Kundt (1839-1894). The govern forces of this phenomenon are acoustic forces which are, however, weak compared with, e.g., viscous forces in the flow, and the formed patterns are highly sensitive to perturbations. Therefore, this phenomenon did not gain widespread technological applications.

Numerous attempts were made to use high frequency ultrasonic standing waves for blood cells sedimentation in containers of the order of milliliters with their subsequent removal. Several techniques were developed for transporting bands of cell or particle clumps along the container axis to achieve efficient cell and particle harvesting. However, all these efforts did not lead to practical applications.

Recently [Hawkes J. and Coakley W., “Forced field particle filter, combining ultrasound standing waves and laminar flow”, 2001, Sensors & Actuators: B Chemical B75, 213], a continuous flow particle filter with 0.25 mm acoustic path length that corresponds to a single half wavelength, was investigated experimentally. High efficiency separation up to 1000 fold was achieved in a single path filter. This technique was based on a combination of macro-engineering for the single path filter and micro-engineering for the part of the channel in which the ultrasound transducer was located.

Another prior art of interest is disclosed in U.S. Pat. No. 6,929,750 and U.S. Patent Application No. 20040069717. A device for separating particle includes a plate formed with channels arranged in a branching fork arrangement. A fluid with suspended particles is introduced into the channels and ultrasound waves are generated from below the plate to form a standing wave in the channels. The acoustic forces bring the particles in the fluid into certain lamina of the fluid, thus leaving one or more laminae devoid of particles. The laminae are arranged perpendicular to the plate such that different laminae can be channeled to different branches of the branching fork.

Additional prior art of relevance includes: International Patent Application Publication Nos. WO 00/04978, WO 98/50133, and WO 93/19367, U.S. Pat. Nos. 5,665,605 and 5,912,182, European Patent No. EP 0773055, and Japanese Patent Nos. JP 06241977 and JP 07 047259.

The present invention provides solutions to the problems associated with prior art techniques aimed at particle separation.

### SUMMARY OF THE INVENTION

According to one aspect of the present invention there is provided a device for manipulating particles present in a fluid medium. The device comprises a planar substrate, formed with at least one primary microchannel to allow passage of the fluid medium therethrough, the at least one primary microchannel having walls and a base and being in fluid communication with a plurality of secondary microchannels via at least one branching point. The device further comprises at least one ultrasound transmission pair, positioned at opposite sides of the walls to generate ultrasound waves propagating through the fluid medium substantially parallel to the planar substrate such as to form a standing wave in the primary microchannel. The standing wave defines an ultrasonically active region within the primary microchannel.

According to another aspect of the present invention there is provided a method of manipulating particles present in a fluid medium. The method starts at a step in which a flow of the fluid medium is by established through the primary microchannel. The method continues to a step in which ultrasound waves are generated. The ultrasound waves propagate through the fluid medium substantially parallel to the planar substrate such as to form a standing wave the primary microchannel. The steps of the method can be performed sequentially or substantially contemporaneously.

According to further features in preferred embodiments of the invention described below, the particles are heavier than the fluid medium.

According to still further features in the described preferred embodiments the particles are lighter than the fluid medium.

According to still further features in the described preferred embodiments the particles are maneuvered within the at least one primary microchannel.

According to still further features in the described preferred embodiments the particles are separated from the fluid medium.

According to still further features in the described preferred embodiments the particles are sorted by size, whereby particles of substantially different sizes are manipulated into different secondary microchannels of the plurality of secondary microchannels.

According to still further features in the described preferred embodiments the standing wave has a velocity anti-node, located along a substantially central region of the primary microchannel, and velocity nodes, located near or at walls of the primary microchannel, such that the particles are accumulated along the velocity anti-node hence being separated from the fluid flowing at regions other than the central region. According to still further features in the described preferred embodiments the primary microchannel has a characteristic width which is about half the wavelength of the standing wave.

According to still further features in the described preferred embodiments the standing wave has a velocity node located near or at one wall of the primary microchannel and a velocity anti-node located near or at the opposite wall of the primary microchannel, such that the particles are sorted by size, whereby large particles are selectively accumulated along the velocity anti-node hence being separated from the fluid and smaller particles flowing at regions being sufficiently far from the opposite wall. According to still further features in the described preferred embodiments the primary microchannel has a characteristic width which is about quarter of the wavelength of the standing wave.

According to still further features in the described preferred embodiments the device comprises a plurality of branching points, and a plurality of ultrasound transmission pairs arranged such that each ultrasound transmission pair defines an ultrasonically active region located upstream a respective branching point.

According to still further features in the described preferred embodiments the primary microchannel comprises linear parts and nonlinear parts arranged such that each linear part is located upstream a respective branch point.

According to still further features in the described preferred embodiments the device comprises a plurality of ultrasound transmission pairs each being aliened substantially parallel to a linear part of the primary microchannel.

According to still further features in the described preferred embodiments the planar substrate is formed with gaps designed and constructed to acoustically decouple different acoustically active regions in the primary microchannel.

According to still further features in the described preferred embodiments the primary microchannel comprises at least one inlet port connectable to a fluid supply unit.

According to still further features in the described preferred embodiments there are two or more inlet ports respectively formed in a plurality of input secondary microchannels being in fluid communication with the at least one primary microchannel via an input branching point.

According to still further features in the described preferred embodiments the input secondary microchannels are arranged such that when different fluids are allowed to flow from different input secondary microchannels into the primary microchannel, at least one fluid interface is formed between the different fluids in the primary microchannel.

According to still further features in the described preferred embodiments one or more of the secondary microchannels comprises an outlet port. According to still further features in the described preferred embodiments the primary microchannel comprises an outlet port.

According to still further features in the described preferred embodiments the device further comprises a control unit capable of controlling the at least one ultrasound transmission pair to provide ultrasound waves of controlled frequency adapted to the transverse dimensions of the primary microchannel, such as to form the standing wave. According to still further features in the described preferred embodiments the control unit is designed and configured to control a phase difference between ultrasound waves generated by a first member of the ultrasound transmission pair and a second member of the ultrasound transmission pair, thereby adjusting the location of nodes and antinodes of the standing wave.

According to still further features in the described preferred embodiments the method further comprising adapting the frequency of the ultrasound waves to the transverse dimensions of the primary microchannel, such as to form the standing wave. According to still further features in the described preferred embodiments the method further comprises adapting a phase difference between ultrasound waves generated at one external side of the walls and ultrasound waves generated at the opposite external side of the walls, thereby adjusting the location of nodes and antinodes of the standing wave.

According to still further features in the described preferred embodiments the device further comprises a flow rate controller to provide a predetermined flow rate to the inlet port. According to still further features in the described preferred embodiments the flow is at a flow rate selected such that fluid flow within the primary microchannel is characterized by Reynolds number which is below 1.

According to still further features in the described preferred embodiments the location and size of the ultrasonically active region is selected such that a characteristic diffusion length of the particles within the fluid medium is short compared to a characteristic transverse size of primary microchannel.

According to still further features in the described preferred embodiments the device further comprising at least one layer of impedance matching material introduced between the at least one ultrasound transmission pair and the walls.

According to still further features in the described preferred embodiments the ultrasound transmission pair comprises a first ultrasound transducer and a second ultrasound transducer. According to still further features in the described preferred embodiments the ultrasound transmission pair comprises an ultrasound transducer and an ultrasound reflector.

According to still further features in the described preferred embodiments the particles comprise biological material.

According to still further features in the described preferred embodiments the biological material contains fatty tissue.

According to still further features in the described preferred embodiments the biological material comprises a microorganism.

According to still further features in the described preferred embodiments the fluid medium comprises blood product.

According to still further features in the described preferred embodiments the blood product comprises whole blood.

According to still further features in the described preferred embodiments the blood product comprises blood component.

According to still further features in the described preferred embodiments the particles comprise erythrocytes present in the blood product.

According to still further features in the described preferred embodiments the particles comprise leukocytes present in the blood product.

According to still further features in the described preferred embodiments particles comprises platelets present in the blood product.

According to still further features in the described preferred embodiments the particles comprise synthetic material.

According to still further features in the described preferred embodiments the particles comprise polymer particles.

According to still further features in the described preferred embodiments the fluid medium comprises saliva.

According to still further features in the described preferred embodiments the fluid medium comprises cerebral spinal fluid.

According to still further features in the described preferred embodiments the fluid medium comprises urine.

The present embodiments successfully address the shortcomings of the presently known configurations by providing a device and method for manipulating particles present in a fluid medium. The device and method of the present embodiments enjoy properties far exceeding the prior art.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-b are schematic illustrations of a prior art particle separation device;

FIG. 2a is a schematic illustration of a device for manipulating particles in a fluid medium, according to various exemplary embodiments of the present invention;

FIG. 2b is a schematic illustration of a branching point of the device, according to various exemplary embodiments of the present invention;

FIG. 3 is a schematic illustration of a multistage device for manipulating particles in a fluid medium, according to various exemplary embodiments of the present invention;

FIG. 4 is a schematic illustration of the device in a preferred embodiment in which the manipulation of particles is achieved by allowing more than one fluid to flow through the microchannel of the device;

FIG. 5a is a schematic illustration of a microchannel of the device in a preferred embodiment in which a velocity anti-node is located along a substantially central region of the microchannel, and velocity nodes are located near or at the walls of the microchannel;

FIG. 5b is a schematic illustration of a microchannel of the device in a preferred embodiment in which a velocity anti-node and a velocity node are located near or at opposite walls of the microchannel;

FIG. 6 shows trajectories of the particles in the transverse direction as a function of time and initial position, as obtained in numerical simulations (lines) and experiments (circles), according to various exemplary embodiments of the present invention;

FIG. 7 shows results of numerical calculations of a clearance coefficient as a function of the fluid discharge, as obtained according to various exemplary embodiments of the present invention;

FIG. 8 shows the experimental frequency dependence of the sound attenuation coefficient in the elastomer, as obtained according to various exemplary embodiments of the present invention;

FIG. 9 shows a clearance coefficient as a function of the fluid discharge, as obtained experimentally according to various exemplary embodiments of the present invention, for 6 different volume concentrations of 5 μm particles;

FIGS. 10a-f are images of particle separation obtained according to various exemplary embodiments of the present invention for the 5 μm particles for volume concentrations of 0.33% (a), 0.5% (b), 1% (c), 5% (d), 7.5% (e) and 10% (f);

FIG. 11 shows the clearance coefficient K as a function of fluid discharge obtained by feeding a 25% solution of rabbit's blood in PBS into a “one-stage” prototype device of the present embodiments;

FIGS. 12a-b are images of blood cells separation from the plasma in a “three-stage” prototype device of the present embodiments, where FIG. 12a is the image of the blood cells during a first separation stage, and FIG. 12b is the image of the blood cells during a second separation stage;

FIG. 13 shows the value of the sorting coefficient, as obtained experimentally according to various exemplary embodiments of the present invention for large (R=m) and small (R=2.5 μm) particles for a 7.2% volume concentration (open circles) and a 1.2% and volume concentration (full circles);

FIGS. 14a-b are images captured during particle size sorting, for the 1.2% volume concentrations, before (FIG. 14a) and after (FIG. 14b) the application of ultrasonic signal, according to various exemplary embodiments of the present invention;

FIGS. 15a-b are images captured during particle size sorting, for the 7.2% volume concentrations, before (FIG. 15a) and after (FIG. 15b) the application of ultrasonic signal, according to various exemplary embodiments of the present invention.

### DESCRIPTION OF THE PREFERRED EMBODIMENTS

The present invention is of a device and method which can be used for manipulating particles in a fluid medium. Specifically, the present invention can be used to maneuver, separate and/or sort particles in the fluid medium.

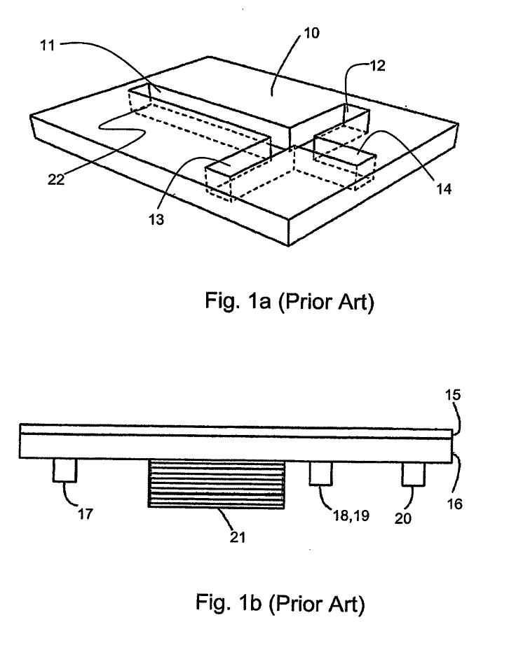

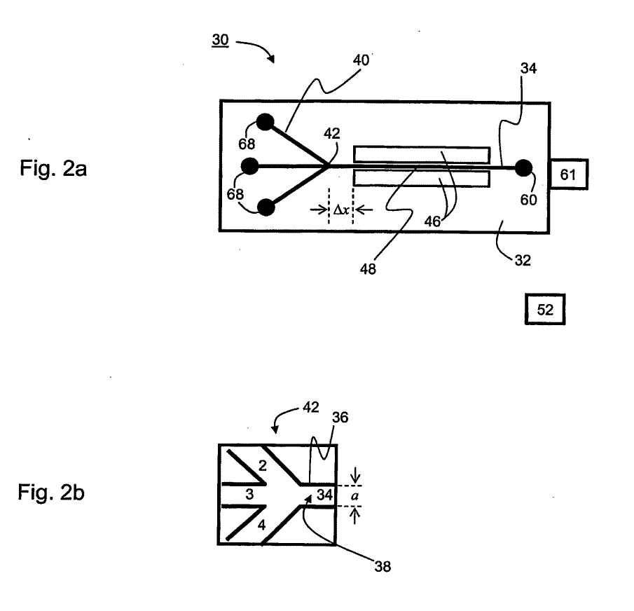

For purposes of better understanding the present invention, as illustrated in FIGS. 2-15 of the drawings, reference is first made to the construction and operation of a conventional (i.e., prior art) particle separation device as illustrated in FIGS. 1a-b.

The prior art device comprises a plate 10, with an integrated channel system having a base stem 11, a left arm 12, a right arm 13 and a central arm 14. The walls 22 of stem 11 are perpendicular to plate 10 and parallel or near parallel to each other. In FIG. 1b the prior art device is shown from the side. As shown the prior art device comprises two layers, one layer 15 including the integrated channel system, and one sealing glass layer 16. A piezoelectric element 21 arranged at the back of plate 10, in acoustic contact with the layer 15. An inlet connections 17 and outlets connections 18, 19 and 20 (connection 19 is behind connection 18) are attached to layer 10 to facilitate fluid communication of external systems (tubes, etc.) with the channel system.

A fluid with suspended particles entering stem 11 through inlet connection 17 flows towards the branching point between stem 11, and arms 12, 13 and 14. At the same time, element 16 generates ultrasound waves propagating upwards perpendicularly to plate 10 and forming a standing wave in the fluid inside stem 11. A stationary wave pattern is thus formed orthogonal to the direction of the flow between the left and right side walls of base stem 11. The stationary wave pattern is characterized by pressure nodes in the middle part of the channel and pressure antinodes at the walls.

During the flow, particles in the fluid tend to accumulate in the pressure nodes or in certain layers in relation to the nodes depending on the density and acoustic impedance of the particles relative to the surrounding fluid. Specifically, particles with a higher density than the fluid tend to accumulate in the nodes, whereas particles with a lower density than the fluid tend to accumulate in the antinodes.

The accumulation of the denser particles in the nodes allows the separation of these particles from the fluid and particles with density which is lower than the density of the fluid. Specifically, the denser particles continue to flow to arm 14 while the fluid and other particles are diverted to left arm 12 and right arm 13.

A major limitation of the prior art device is that it can not discriminate between particles of different densities if the different densities are higher than the density of the fluid. Thus, for example, when the fluid contains two types of particles both having densities which are high compared to the fluid density, the two types of particles flow into arm 14 and are not separated.

The present embodiments successfully provides a device and method for manipulating particles in a fluid medium, which device and method provide solutions to the problem associated with the prior art device. As further explained hereinbelow, there are many particular features of the present invention which allow efficient particle manipulation in the fluid medium. For example, unlike the prior art device, in various exemplary embodiments of the invention the device and method can be used to manipulate (e.g., maneuver, sort, separate) the particles rather than just to separate them from the fluid medium. In other exemplary embodiments of the invention the device and method can be manipulate particles which are heavier than the fluid medium as well as particles which are lighter than the fluid medium.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Reference is now made conjointly to FIGS. 2-4, which are schematic illustrations of a device 30 for manipulating particles present in a fluid medium, in accordance with various exemplary embodiments of the present invention.

Device 30 comprises a planar substrate 32, formed with one or more primary microchannels 34 having walls 36 and a base 38 (see FIG. 2b) to allow passage of the fluid medium therethrough. Primary microchannel 34 is in fluid communication with a plurality of secondary microchannels 40 via one or more branching points 42. A illustrative example of branching point 42 is provided in FIG. 2b.

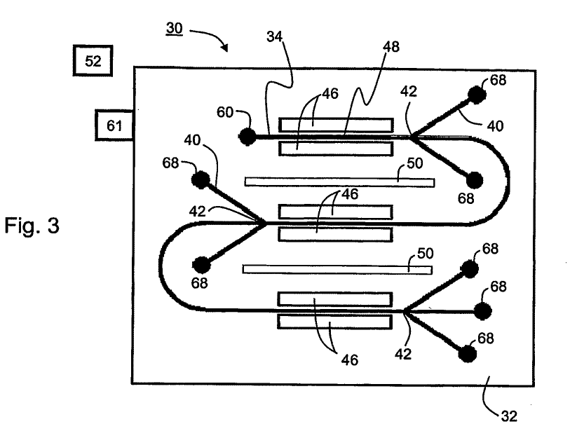

Primary microchannel 34 can be a linear microchannel, as shown in FIG. 2a, or it can have linear parts and nonlinear parts, as shown in FIG. 3. Other configurations for microchannel 34 are also contemplated. When there is more than one branching point (see, for example, the three branching points in FIG. 3) each branching point is preferably located such as to allow the fluid to furcate upon arrival the branching point. Preferably, but not obligatorily, the part of microchannel 34 which feeds the branching point with the fluid is linear. Thus, for example, when microchannel 34 has linear parts and nonlinear parts, each linear part is preferably located upstream a respective branch point.

Device 30 further comprises one or more ultrasound transmission pairs 46, positioned at opposite sides of the walls of microchannel 34. Ultrasound transmission pairs 46 serve for generating ultrasound waves propagating through the fluid medium such as to form a standing wave defining an ultrasonically active region 48 within microchannel 34. Thus, unlike the prior art device (see FIGS. 1a-b), in which the ultrasound transducer is positioned below the plate to generate ultrasound waves propagating perpendicularly to the plate, the ultrasound transmission pairs of the present embodiments generate ultrasound waves propagating substantially parallel to substrate 32.

As will be appreciated by one of ordinary skill in the art, there is a certain relation between the transverse size of the microchannels and the wavelength of the ultrasound waves. Specifically, the ratio a/λ, between the width, a, of microchannel 34 and the wavelength, λ, of the ultrasound wave is selected so as to fulfill the standing wave condition. It was found by the inventor of the present invention that significant efficient particles manipulation can be achieved when the frequency of the acoustic signal is of the order of several megahertz or more. For such frequencies the preferred transverse dimensions of microchannels 34 and 40 are from about 10 μm to 500 μm in width and/or depth. It is to be understood, however, that this is not to be considered as limiting and that other transverse dimensions are not intended from the scope of the present invention.

The length of each of the microchannels can vary, depending on the type of particle manipulation for which device 30 is employed. As a representative non-limiting example, the overall length of the primary microchannel is from about 2 cm to about 20 cm, and the length of each secondary microchannel is from about 1 cm to about 5 cm.

As used herein the term “about” refers to ±10%.

Ultrasound transmission pair 46 can be an ultrasound transducer/reflector pair, or, more preferably an ultrasound transducer/transducer pair. The use of transducers at both sizes of microchannel 34 is preferred because it allows better control on the locations of the nodes in the formed standing wave. The acoustical contact between the ultrasound transmission pairs and microchannel 34 is preferably achieved via one or more layers of impedance matching materials, introduced between the ultrasound transmission pair and the walls of the microchannel. Representative examples of such impedance matching materials are provided in the Examples section that follows. When more than one ultrasound transmission pair is employed, the pairs are preferably separated by gaps 50 designed and constructed to acoustically decouple different acoustically active regions in microchannel 34. The gap can be filled with any suitable material (e.g., air) which can prevent or reduce interference between the ultrasound waves of different active regions. According to a preferred embodiment of the present invention ultrasound transmission pair 46 is aligned substantially parallel to microchannel 34 or a portion thereof.

To manipulate particles in the fluid medium, one or more fluids are delivered to microchannel 34, e.g., via one or more inlet ports 60. The fluid or fluids can be delivered to microchannel 34, by a fluid supply unit 61 which can be or comprise a flow rate controller to ensure a predetermined flow rate to inlet port 60. A more detailed description of a flow rate controller is provided in the Examples section that follows. Once the fluid or fluids are delivered a flow is established through microchannel 34 and the particles in the fluid(s) are manipulated by acoustical forces induced by ultrasound transmission pairs 46, as further detailed hereinafter. According to a preferred embodiment of the present invention the flow rate is selected such that fluid flow within primary microchannel is characterized by Reynolds number which is below 1. The fluid(s) and/or particles can be evacuated from device 30 through one or more outlet ports 68.

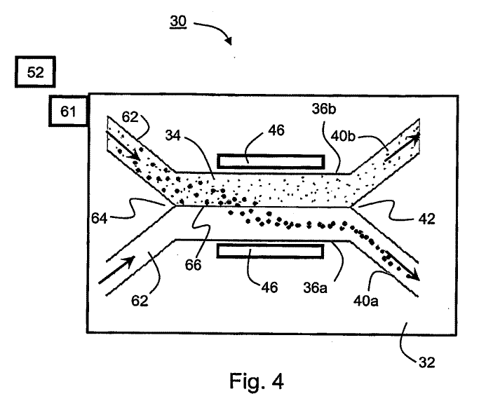

Device 30 can also comprise one or more input secondary microchannels 62. (see FIG. 4) being in fluid communication with microchannel 34 via an input branching point 64. This embodiment is particularly useful when it is desired to allow different fluids to flow through microchannel 34. In this embodiment each such fluid is delivered to microchannel 34 through a different input secondary microchannel. The input microchannels can be designed and constructed such that one or more fluid interfaces are formed between different fluids in microchannel 34. For example, a particle containing fluid can be delivered through one input microchannel and a fluid devoid of particles can be delivered through another input microchannel. Under the influence of the acoustic forces particles can be manipulated through the fluid interface between the two fluids.

Before providing a further detailed description of the method and device for manipulating particles in fluid medium, as delineated hereinabove and in accordance with the present embodiments, attention will be given to the theoretical considerations made by the present Inventors while conceiving the present invention.

When an acoustic wave propagates through the fluid medium at a sound velocity c such that a standing wave is formed, individual particles present in the fluid are subjected to a primary acoustic force, acting in an axial direction to the propagation direction of the sound wave. The primary acoustic force is proportional to the volume of the particle and the frequency of the acoustic wave and is typically much larger than particle-particle interaction force originating from the scattering of the incident wave (also known as Bjerknes force, after Vilhelm Bjerknes 1862-1951). The contribution of the Bjerknes force is neglected in the following description.

For a particle having a radius R which is much smaller than the sound wavelength λ (kR<<1, where k=2π/λ is the sound wave number), the primary acoustic force is given by the approximation of zero viscosity by:

$${\overline{F}}_{st} = \frac{2 {π ( kR )}^{3} 2 {\overline{E}}_{st}}{{k}^{2}} Φ ( Λ , σ ) sin 2 {k}^{ρ} {{r}^{ρ}}_{0} , \qquad ( EQ . 1 )$$

where Ēₛₜ is the energy density of the standing waves; Λ=ρₚ/ρ is the ratio between the density of the particle, ρₚ, and the density of the fluid, ρ, σ=cₚ/c is the ratio of the sound velocity of a particle, cₚ, and the sound velocity of the fluid, c; [symbol] ₀ is the vector normal to the force node, and

$$Φ ( Λ , σ ) = \frac{1}{3} ( \frac{5 Λ - 2}{2 Λ + 1} - \frac{1}{Λ {σ}^{2}} ) \qquad ( EQ . 2 )$$

In the field of the standing wave, particles accumulate in nodes of the acoustic force (or in antinodes of the velocity field). Thus, the application of ultrasound waves on the particles containing fluid medium, results in separation of the fluid medium from the particles, whereby regions other than force nodes are substantially devoid of particles.

From Equations 1 and 2 it is seen that the radiation force is proportional to the particle volume and to the acoustic frequency f=ck/2π. A significant phenomenon is achieved when the frequency of the acoustic signal is of the order of several megahertz or more. The use of high frequency sound is also advantageous because it minimize or eliminate formation of cavitation. Since high frequencies correspond to short wavelengths, the use of high frequency ultrasound waves to manipulate particles in the fluid medium is typically implemented in microfluidic channels with characteristic dimension on the order of half of the wavelength of the ultrasound sound. Short acoustic path length in this case makes the microfluidic channels also more practical from a sound attenuation point of view.

According to various exemplary embodiments of the present invention, the fluid flow within the microfluidic channel is substantially laminar so as to eliminate or reduce transverse mixing of the particles by the flow. As will be appreciated by one ordinarily skilled in the art, substantially laminar flow is characterized by a low Reynolds number, which depends on the flow rate, the characteristics of the fluid (density, viscosity) and the transverse dimension of the microchannel. According to a preferred embodiment of the present invention the fluid flow within the micro channel is characterized by Reynolds number which is below 1. For example, for a microchannel having transverse dimensions of about 160 μm×150 μm, solution density of 1.027 gr/cm³, viscosity of 1 centistoke and flow rate of about 100 nl/s, the corresponding Reynolds number is about 0.7.

During the separation of the particles from the fluid medium, a fluid interface is formed between the part of fluid which still contains particles and the part of the fluid which is substantially devoid of particles. Additionally, as further detailed hereinunder and demonstrated in the Examples section that follows, in preferred embodiments of the present invention the primary fluid channel is fed by pure fluid from one inlet and particles-containing fluid from another inlet to form the fluid interface between the two fluids.

Due to diffusion process occurring across the interface, the interface can be smeared out with time. The diffusion length, h, traversed by particles during time t can be found from the relation h=\sqrt{2Dt} where D is the particle diffusion coefficient defined as

$$D = \frac{{k}_{B} T}{6 π η R} , \qquad ( EQ . 3 )$$

where k_{B}=1.38·10⁻¹⁶ erg/° K is the Boltzmann constant, T is the temperature and η is the fluid viscosity.

According to a preferred embodiment of the present invention the traveling time of the particles within the channel is selected such that the characteristic diffusion length of the particles is small compared to the characteristic transverse size of the channel. Denoting the characteristic transverse size of the channel by a, the characteristic diffusion length, h, is preferably shorter than a predetermined threshold h₀ which is preferably shorter than 0.1a, more preferably shorter than 0.05a, even more preferably shorter than 0.01a, say about 0.05a or less. Thus, for a given characteristic diffusion length, h<h₀, the traveling time t is preferably t=h²/2D.

Appropriate traveling time can be achieved by judicial selection of the flow rate Q of the fluid medium and/or the distance Δx between the ultrasonically active region 48 and branching point 42 (see FIG. 2a). For example, for Δx≈2 mm and Q≈100 nl/s the traveling time t is about 0.48 μs. For particles with R=5 μm and temperature T of about 295° K., the corresponding diffusion length h is about 0.2 μm, which is about 0.2% of the characteristic transverse size of the channel.

In the case of negligible particle diffusion, the probability density function of the particles at the velocity anti-node is given by:

ψ=ψ₀exp [t/τᵣₑₗ], (EQ. 4)

where τₛₜ=3η/4ĒₛₜΦ(kR)² is the characteristic relaxation time for the particle distribution dynamics. The energy density Ēₛₜ can be estimated from the expression Ēₛₜ=8β(πfd₃₃U)²ρTₜᵣ where d₃₃ is the longitudinal piezoelectric sensitivity of the ultrasound transducer, U is the applied voltage on a transducer, Tₜᵣ is the transmission coefficient and β is a fitting parameter which is typically lower than unity. The transmission coefficient represents the amount of ultrasound energy which is successfully transmitted into the fluid medium and can be selected by introducing suitable impedance matching materials between the transducer and the fluid medium. The β parameter represents energy loses due to various phenomena, such as absorption in surrounding materials, diffraction, interference and attenuation in the fluid medium. For example, for Tₜᵣ=0.23, β=0.2, d₃₃=290·10⁻¹² C/N, ρ=1.027 gr/cm³, η=1 centistoke, f=5 MHz and U=10 V, the corresponding value of τᵣₑₗ is 0.5 seconds.

According to a preferred embodiment of the present invention, device 30 comprises a control unit 52 which controls pairs 46 to provide ultrasound waves of controlled frequency. The controlled frequency is adapted to the transverse dimensions of microchannel 34 such as to form the standing wave therein. When pair 46 is a transducer/transducer pair in which both transducer members operates at the same frequency, control unit 52 can control the phase difference between the ultrasound pulses of the transducer members thereby to adjust the position of the nodes in microchannel 34.

By controlling the frequency and/or phase difference of the ultrasound waves a standing wave is formed between the side walls 36 of microchannel 34 with a predetermined width-to-wavelength ratio, a/λ, of, e.g., 0.25, 0.5, 0.75, etc. The frequency and/or phase difference selected by unit 52 depend on the desired location within microchannel 34 to which the particles are manipulated.

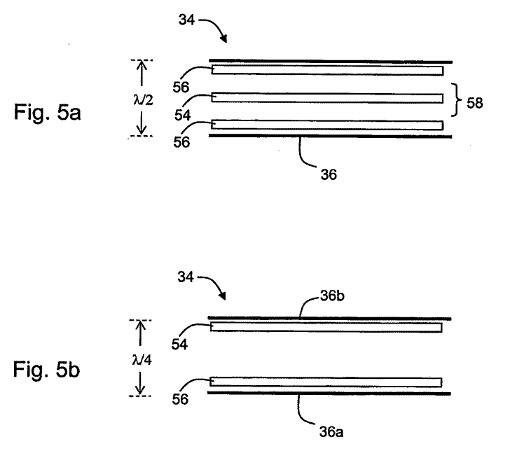

For example, in one preferred embodiment, the frequency and/or phase difference is selected such as to form a standing wave having a wavelength λ which is twice the width a of microchannel 34. Referring to FIG. 5a, the standing wave preferably has a velocity anti-node 54, located along a substantially central region 58 of microchannel 34, and velocity nodes 56, located near or at walls 36. Thus, according to the presently preferred embodiment of the invention the particles are accumulated along anti-node 54 hence being separated from the fluid flowing at regions other than central region 58. Upon reaching branching point 42, the particles and fluid at central region 58 continue to flow in microchannel 54 while the remaining portion of the fluid (which is devoid of, or contains fewer particles) can be evacuated via secondary channels 40. When device 30 comprises more than one branching point, the above separation process is preferably repeated before each branching point, so as to further evacuate more fluid from the particles. Thus, in this embodiment, device 30 serves as a multistage device.

In another preferred embodiment, the frequency and/or phase difference is selected such as to form a standing wave having a wavelength which is four times the width of microchannel 34. Referring to FIG. 5b, the velocity anti-node 54 and the velocity node 56 are preferably located near or at opposite walls of microchannel 34. Thus, in this embodiment, the particles are accumulated near one wall (designated by numeral 36a) of microchannel 34 and being separated from the fluid flowing near the other wall (designated by numeral 36b). This embodiment is particularly useful when device 30 is used for sorting the particles by their size, as further explained hereinbelow.

In a search for a method and device for sorting particles by size, the Inventors of the present invention have observed by that the velocity of the particles strongly depends on their size. This is because the force on the particles is proportional to R³ (see Equations 5 and 6 in the Examples section that follows) and characteristic relaxation time τᵣₑₗ of the particle is inversely proportional to R² (see Equation 4). Thus, larger particles move faster than smaller particles. Such dependence allows separating the large particles from the small particles present in the fluid medium. Specifically, when the fluid medium contains a spectrum of particles of different sizes, the ultrasound waves can be used to exert different forces on particles of different sizes, thereby to provide them with different velocities and to maneuver them to different locations within the fluid channel.

A preferred embodiment for sorting particles by size is schematically illustrated in FIG. 4. Microchannel 34 is fed (via input microchannels 62 and input branching point 64) by two fluids: a particle containing fluid which flows at the side of wall 36b, and a substantially particle free fluid (“pure” fluid), which at the side of wall 36a. The position of velocity node and velocity anti-node can be selected so as to maneuver the particles of interest from one wall, say, wall 36b of microchannel 34 to the other wall (wall 36a in the present example). The specific walls at which the velocity node and antinodes are formed depend on the relative weight of the particles of interest. Suppose, for example, that it is desired to maneuver the particles of interest from wall 36b to wall 36a. In this case, if the particles of interest are heavier than the fluid medium, the velocity anti-node is preferably formed near or at wall 36a and the velocity node is preferably formed near or at wall 36b; and if the particles of interest are lighter than the fluid medium, the velocity node is preferably formed near or at wall 36a and the velocity anti-node is preferably formed near or at wall 36b.

In such configuration, upon application of the ultrasound waves, the particles begin to move towards wall 36a while traversing the interface 66 between the two fluids. Upon reaching branching point 42, a portion of the fluid continues at secondary microchannel 40b and another portion continues at secondary microchannel 40a (or continues in primary microchannel 34 if branching point 42 is constructed in such manner). Yet, as stated, the larger particles move faster than the smaller particles. Hence, before reaching branching point 42 the number of large particles traversing the interface is greater than the number of small particles traversing interface. As will be appreciated by one of ordinary skill in the art, such construction allows sorting the particles by size. As will be further appreciated, the generation of a standing wave such that the width of microchannel 34 is a quarter of the wavelength of the standing wave ensures that a maximal acoustic force is applied on the large particles, thus provide efficient size sorting. Similarly to the above, when device 30 comprises more than one branching point, the size sorting process is preferably repeated before each branching point, so as to further sort the particles by size.

The device of the present embodiment can be used for manipulating (e.g., maneuvering, separating, sorting) many types of particles present in many types of fluid medium. The particles can comprise organic, inorganic, biological, polymeric or any other material. For example, the fluid medium can comprise blood product, either whole blood or blood component, in which case the particles can be erythrocytes, leukocytes, platelets and the like. The fluid medium can also comprise other body fluids, include, without limitation, saliva, cerebral spinal fluid, urine and the like.

The particles can comprise other biological materials, such as, but not limited to, cells, cell organelles, platelets, inorganic, organic, biological, and polymeric particles which are optically visible, a biological material which contains a fatty tissue or a microorganism. The particles which are manipulated by the device and method of the present embodiments can also be made of or comprise synthetic (polymeric or non-polymeric) material, such as latex, silicon polyamide and the like.

It is expected that during the life of this patent many relevant particles and fluids will be developed or found and the scope of the terms particles, particles manipulation, particles separation and particles sorting is intended to include all such new technologies a priori.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Example 1

### Numerical Simulations

The present example provides a mathematical model for describing the dynamics of a particle in a channel flow. The equation of motion for a particle in a viscous medium carrying an ultrasonic standing wave can be written as:

mÿ=Fₛₜ sin(2ky)−C\dot{y}, (EQ. 5)

where m is the particle mass, C=6πηR is the Stokes coefficient, Fₛₜ is the amplitude of the ultrasonic force, and y is the coordinate across the channel. The dots above the coordinate y commonly represent a time-derivative, as known in the art. The relation between the ultrasonic force and energy density is given by (see also Equations 1 and 2 above):

Fₛₜ=4πkR³ĒₛₜΦ(Λ,σ). (EQ. 6)

Equation 5 was solved numerically using the values of Fₛₜ=2.5×10⁻⁶ dyn and C=0.94×10⁻⁴ g/s, corresponding to R=5 μm, k=209.4 cm⁻¹, Ēₛₜ=35 erg/cm³, Φ=0.22 and η=1 centistoke. As stated, the fitting parameter β was introduced to account for energy loses.

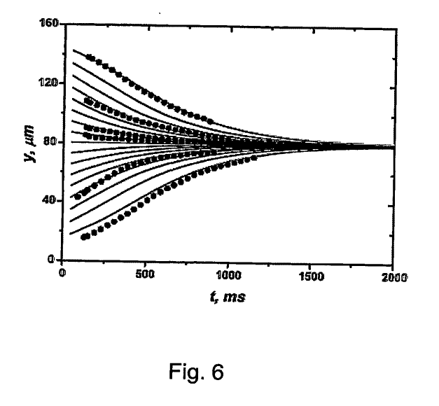

FIG. 6 shows the obtained trajectories of the particles in the transverse direction as a function of time and initial position, for β=0.2. This value corresponds to effective force amplitude of 5×10⁻⁷ dyn. In FIG. 6, the solid lines correspond to the results of numerical simulations and the dots correspond to the experimental data (see Example 2 hereinunder). As shown in FIG. 6 there is a good agreement between the measurements and the simulations.

Numerical simulations were also conducted to determine the clearance coefficient, defined as K=Nₒᵤₜ/(Nᵢₙ−Nₒᵤₜ) as a function of the flow rate, Q, where Nᵢₙ and Nₒᵤₜ are the initial and final concentration of particles in the inlet and outlet channels, respectively. K is related to the separation efficiency, S_{eff}, defined as S_{eff}=Nₒᵤₜ/Nᵢₙ×100%, via K=S_{eff}/(100−S_{eff}).

The numerical simulations were performed by means of Equations 5 and 6 above (with β=0.2), for a rectangular cross-section microchannel (−a≦y≦a, −b≦z≦b) with 1 cm long transducers. The microchannel had one inlet and the fork enacted the outlet (see FIG. 2a). Gravitational effects were neglected. For the flow discharge the following expressions was used:

$$\begin{matrix}u ( y , z ) ≡ x \& = \frac{16 {a}^{2}}{η {π}^{3}} ( - \frac{d p}{d x} ) {\sum }_{i = 1 , 3 , 5 …}^{∞} {( - 1 )}^{( i - 1 ) / 2} \{ 1 - \frac{cosh ( i π z / 2 a )}{cosh ( i π b / 2 a )} \} \frac{cos ( i π y / 2 a )}{{i}^{3}} , \\ and & ( EQ . 7 ) \\ Q = \frac{4 {ba}^{3}}{3 η} ( \frac{d p}{d x} ) \{ 1 - \frac{192 a}{{π}^{5} b} {\sum }_{i = 1 , 3 , 5 …}^{∞} \frac{tanh ( i π b / 2 a )}{{i}^{5}} \} . & ( EQ . 8 )\end{matrix}$$

Equations 7 and 8 assumes that a particle follows a fluid element in the flow direction, x, without delay. In other words, the particle and fluid velocities in the x-direction are the same, [symbol] =u(y,z).

The numerical solution were performed for large number of particles with different initial locations in transverse direction to the flow, and assuming that all particles that reach the area of the velocity anti-node are extracted from the flow.

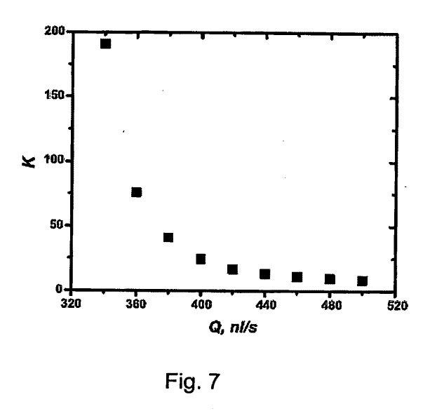

The results of the numerical calculations of the clearance coefficient as a function of the fluid discharge are shown in FIG. 7.

### Example 2

### Prototype Device

Prototype devices were manufactured and tested according to various exemplary embodiments of the present invention. Three prototypes designs were manufactured, two for particle separation and one for size sorting. The prototype devices for particle separation are schematically illustrated in FIGS. 2a-b (“one-stage” device) and FIG. 3 (“three-stage” device), and the prototype device for size sorting is schematically illustrated in FIG. 5.

### Materials and Methods

Molds for microchannels were produced by a soft lithography technology using UV-sensitive epoxy (SU-8). A microfluidic chip was made of a silicone elastomer Sylgard 184 (specific gravity 1.05 gr/cm³ at 25° C., linear thermal expansion coefficient is 3·10⁴ cm/cm per ° C.) with curing time of 4 hours at 65° C.

The cross-sectional dimensions of the microchannel for particle and erythrocytes separation were 160 μm (about half the sound wavelength, λ) in width and 150 μm in depth. The dimensions of the microchannel for size sorting were 100 μm (about quarter of wavelength) in width and 120 μm in depth. The longitudinal dimension of the channel was 1.5 cm and the size of the ultrasonically active region within the channel was about 1 cm.

Transducers (Ferroperm Piezoceramics, type PZ26) were used as emitters of ultrasound waves. For impedance matching between the transducers and the solvent, a thin glass and an elastomer were introduced between the transducers and the solvent. The transducers were positioned such as to minimize refraction thereby allowing to use the expression 4 ZᵢZᵢ₊₁/(Zᵢ+Zᵢ₊₁)² for calculating the transmission coefficient between two successive materials having impedances Zᵢ and Zᵢ₊₁. Specifically, for an impedance sequence of Z₁=31.4 MRayl (ultrasound transducer), Z₂=13 MRayl (glass), Z₃=1.07 MRayl (elastomer), and Z₄=1.5 MRayl (solution), the overall transmission coefficient Tₜᵣ is about 0.23.

It is noted that optimal transmission coefficient can be achieved by adding several layers of quarter-wavelength matching materials with consequently reduced values of acoustic impedance between piezoceramics (31.4 MRayl) down to water (1.5 MRayl). Ideally, optimal impedance matching is achieved by selecting the impedance of the ith layer of matching material to be Zᵢ=\sqrt{Zᵢ₋₁Zᵢ₊₁}. More practically, three quarter-wavelength layers of lead (24 MRayl), glass (13 MRayl) and mylar (3 MRayl) can results in a total transmission coefficient Tₜᵣ of about 0.41.

Instead of transducer and reflector, a pair of transducers aligned parallel to the microchannel was used. The transducers were operated at the same frequency to create a standing ultrasound wave, and the position of the node was controlled by varying the phase difference between the transducers.

The transducers were mounted on both sides of a micro-channel in air pockets produced in elastomer via the soft lithography at a distance 800 μm from the center of the channel.

Sinusoidal signals, applied to the transducers, were obtained from two phase-locked function generators (Hewlett Packard, model 3325B), and amplified by RF power amplifier (IntraAction, model PA-4). The transducers were calibrated by reciprocal methods.

Large driving amplitudes were used for sound transducers so as to increase the driving force for the particle separation. It was found that the limiting factor is the temperature increase of the solution that can reach tens of degrees. To control and monitor the temperature of the solution, a precise small thermistor was incorporated into the elastomer. The sound amplitude in the solution was estimated by measuring the sound attenuation coefficient as a function of frequency for the elastomer.

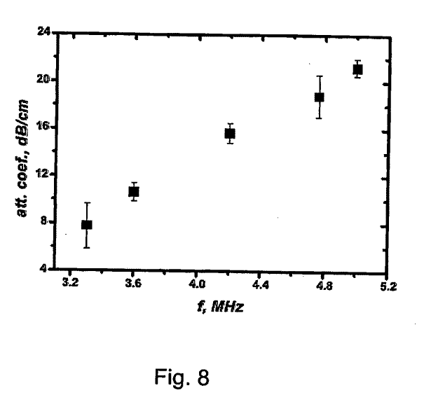

FIG. 8 shows the experimental frequency dependence of the sound attenuation coefficient in the elastomer. As shown, the frequency dependence of the attenuation coefficient is close to linear. Similar measurements were also performed for perspex (lucite) and RTV (silicone resin), for comparison. It was found that the attenuation coefficient of the elastomer was similar to the attenuation coefficient of the perspex and larger than the attenuation coefficient of the RTV.

Commercially available R=5±1 μm particles (ORGASOL 2002 EXD NAT 1, ultrafine powder of polyamide 12, with a narrow particle size distribution and nearly round particle shape) were used for the particle separation experiment. Similar particles of R=2.5±0.5 μm and R=10±1 μm were also used in size sorting experiments. The properties of the 2.5 μm and 10 μm particles were density ρₚ=1.03 gr/cm³ and the sound velocity cₚ=2.4·10⁵ cm/s. Water solutions at different particle concentrations were prepared according to the following protocol: surfactant (MAFO CAB-BASF)-6.8%; polymeric dispersant (polyacrylate salt, Darvan 7-Vanderbilt)-2.5%; defoamer (Plurafac RA4O-BASF)-1.4%; water-89.3%.

The solutions were fed into the microchannels of the prototype devices of the present embodiments via a flow rate controller to ensure a precise and stable flow rate. The flow rate controller included a micro-syringe coupled to a stepping motor, which was driven by a stepping motor controller (Panther L12). The stepping motor controller was connected to a computer via COM port and operated using MATLAB™ software. The experiments were conducted at the several flow rates, Q: 54, 81, 90, 108, 135, 162, and 190 nl/s, for particles separation and 17, 20, 28, 33, 40 and 45 nl/s, for size sorting. For the above microchannel dimensions and a solution density of 1.027 gr/cm³, the above flow rates correspond to Reynolds numbers of less than a unity.

The particles were observed using a Leitz Orthoplan polarized microscope. The micro-channel was fixed on the translational stage of the microscope. A CCD camera (Panasonic, model BP31O with built-in shutter) and the frame grabber (Ellips RIO) were used in order to Capture and digitize images. The pixel size was 2.2×1.1 μm with a 4× objective. In the size sorting experiments the pixel size was 1.2×0.6 μm with a 10× objective and CCD camera Cohu 4710.

The images were processed by one of two algorithms, depending on the particle concentration, quality of images and the number of the outgoing particles.

The first algorithm was based on detecting of a particle shape and counting of the number of particles at five specific locations along the channels. The clearance coefficient, K, was calculated as the concentration ratio of outgoing (central outlet channel) and remaining particles in the filtered solution (two side outlet channels). The number of particles per volume in a certain part of the channel was used to define concentration of particles in this part of the channel.

The second algorithm was based on a calculation of the intensity profile due to particle light scattering across a certain part of the channel. Then the clearance coefficient was calculated as the ratio of the intensity integrals.

Three experiments were performed. Two experiments (referred to hereinafter as experiments 1 and 2) were directed to the study of continuous particle separation, and one experiment (referred to hereinafter as experiment 3) was directed to continuous size sorting.

In experiment 1, the clearance coefficient K(Q) and separation efficiency of the prototype devices of the present embodiments were studied for 6 different volume concentrations of the 5 μm particles: 0.33%, 0.5%, 1%, 5%, 7.5% and 10%.

In experiment 2, the prototype devices of the present embodiments were used for separating blood cells from the plasma. A solution of 25% of rabbit's blood in Phosphate Buffered Saline (PBS) was fed into the prototype devices, and the corresponding clearance coefficient K(Q) and separation efficiency were studied.

In experiment 3, particle size sorting was studied by feeding a solution containing particle of different sizes (R=2.5 μm and R=10 μm) to the prototype device schematically illustrated in FIG. 5. Solutions with two different volume concentrations of particles were used a 1.2% concentrations solution and a 7.2% concentrations. The concentrations of large and small particles in the outlet channels and the inlet channel of the device were measured and a size sorting coefficient, K_{c}, was calculated for each solution. K_{c} was defined as K_{c}=N_{L,out}/(N_{L,in}−N_{L,out}), where N_{L,out} and N_{L,in} are the concentration of large particles in the outlet and inlet channels, respectively.

### Results

### Experiment 1

### Continuous Particle Separation

Clearance coefficient K(Q) measurements for the 5 μm particles were preceded by measurements of particle trajectories for different initial locations, from which the value of the β parameter (quantifying the correction for the theoretical acoustic energy density) was determined. Good agreement between the measurements and the simulations were obtained for β=0.2 (see FIG. 6 in Example 1 hereinabove).

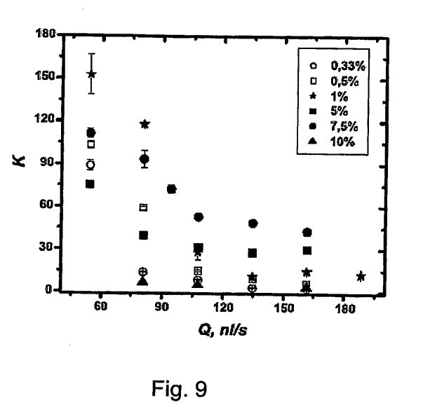

FIG. 9 shows the clearance coefficient K(Q) as a function of the fluid discharge obtained experimentally for the 6 different volume concentrations of the 5 μm particles. The results shown in FIG. 9 are generally of the same type as the numerical simulations (see FIG. 7). There are two main reasons for the differences in absolute values of K for the different concentrations. Firstly, the absolute values of K for the 0.33% concentration are smaller then those for higher concentrations up to 7.5% due to casual particles located outside the velocity anti-node. Their destructive contribution to K is larger for smaller concentrations and lower for higher concentrations. For this reason the values of K are the highest for the 1% concentration. Secondly, the scattering of ultrasonic waves off particles is higher for high concentrations and lower for low concentrations.

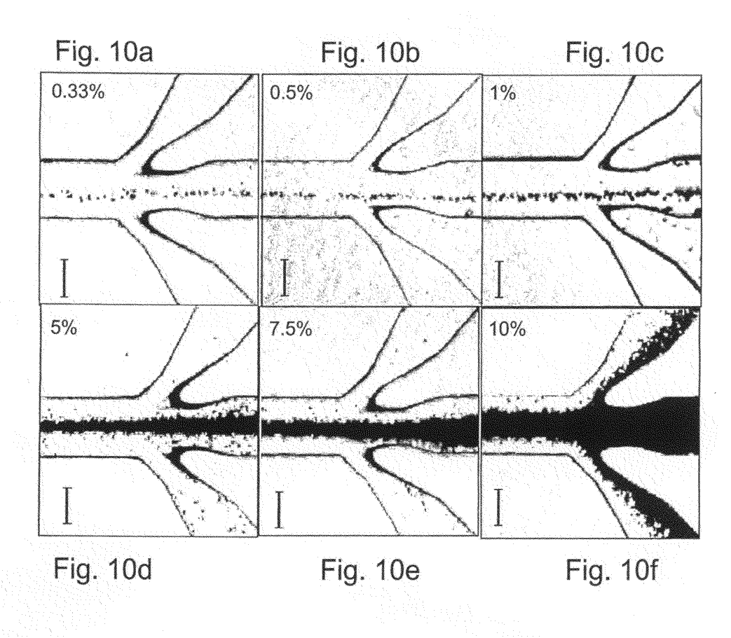

FIGS. 10e-f are images of particle separation of obtained for the 5 μm particles for the 0.33%, 0.5%, 1%, 5%, 7.5% and 10% concentrations, respectively. The bar at the bottom left corner of each image represents a 100 μm length. As shown in FIGS. 10e-f, the relative volume of particles in solution due to their concentration affects the separation efficiency.

Using the “three-stage” prototype device (see FIG. 3) at a flow rate of Q=162 nl/s, a clearance coefficient of K=3826 for 5 μm particles at concentration 5% was achieved.

### Experiment 2

### Continuous Blood Cells Separation From Plasma

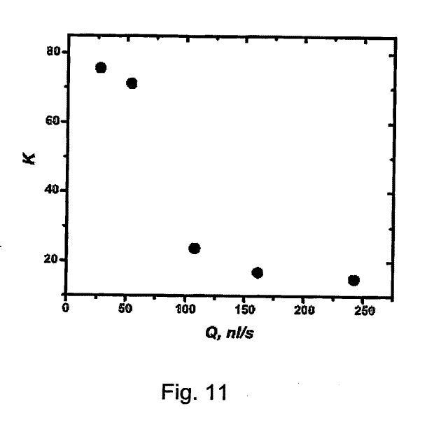

FIG. 11 shows the clearance coefficient K as a function of fluid discharge obtained by feeding the 25% solution of rabbit's blood in PBS into the microchannels of the “one-stage” prototype device of the present embodiments. As shown in FIG. 11, the value of K is high for low of fluid discharge and low for high fluid discharge. A sharp decrease in the clearance coefficient was observed in from Q=50 nl/s to Q=100 nl/s.

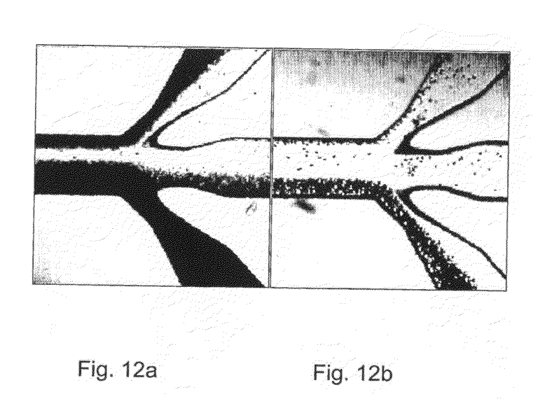

FIGS. 12a-b are images of blood cells separation from the plasma in the “three-stage” prototype device of the present embodiments, where FIG. 12a is the image of the blood cells during the first separation stage, and FIG. 12b is the image of the blood cells during the second separation stage. The maximal clearance coefficient obtained using the “three-stage” prototype device was about 4000, at a flow rate of Q=162 nl/s, corresponding to S_{eff}=99.975%.

It is therefore demonstrated that the device of the present embodiments is capable of efficiently separating particles and blood cells from a solution. High separation efficiency, in particular in the “three-stage” prototype device, for particles and blood cells makes the device of the present embodiments commercially applicable.

### Experiment 3

### Continuous Particle Size Sorting

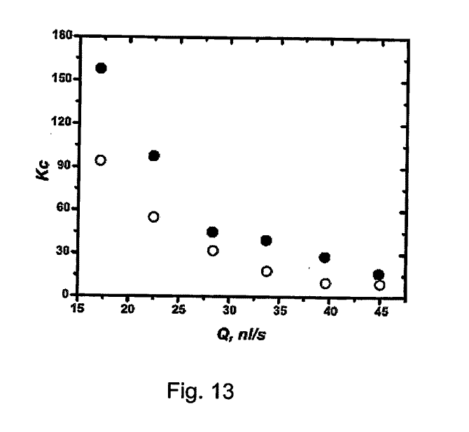

FIG. 13 shows the value of the sorting coefficient (K_{c}=N_{L,out}/(N_{L,in}−N_{L,out}), as obtained experimentally for large (R=10 μm) and small (R=2.5 μm) particles for the 7.2% volume concentration (open circles) and the 1.2% volume concentration (full circles). As shown, the sorting coefficient decreases with the flow rate. Still, rather high values of K_{c}, from about 10 (for Q=45 nl/s) to about 170 (for Q=17 nl/s), were obtained.

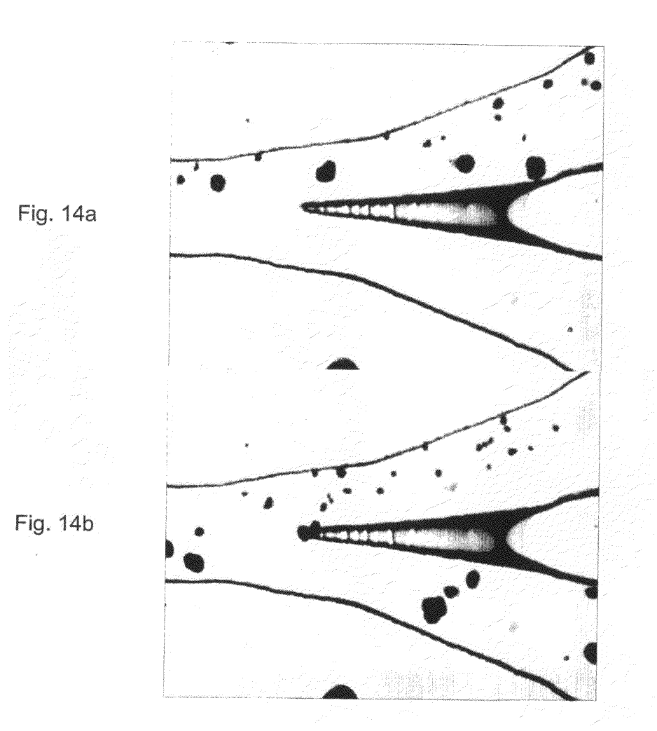

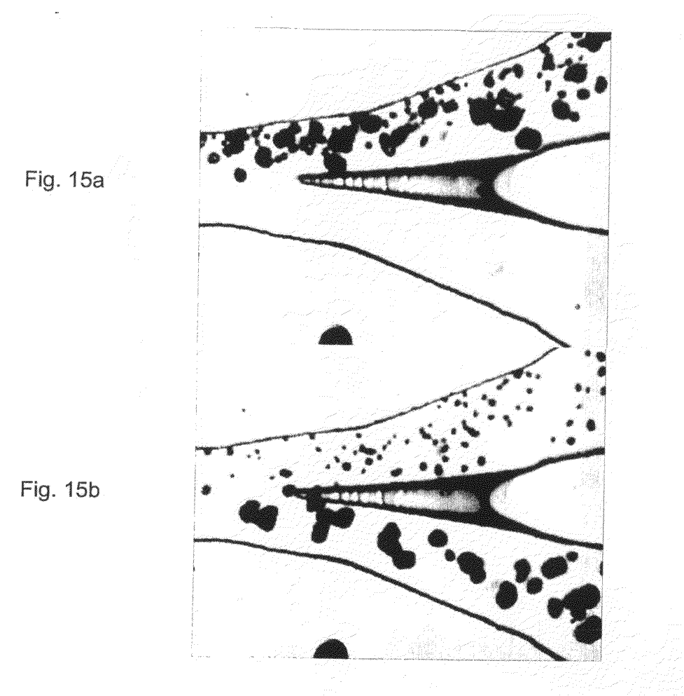

FIGS. 14a-b and 15a-b are images captured during particle size sorting, for the 1.2% (FIGS. 14a-b) and the 7.2% (FIGS. 15a-b) volume concentrations, before (FIGS. 14a and 15a) and after (FIGS. 14b and 15b) the application of ultrasonic signal. As shown in the images, before the application of the ultrasound waves, all particles occupy the upper outlet channel of the device. The ultrasound waves direct the large particles to the lower outlet channel and the small particles to the upper channel.

It is therefore demonstrated that the prototype device, manufactured according to the teaching of preferred embodiments of the present invention, successfully sort the particles by their size. The relatively simple and efficient device of the present embodiments can therefore replace rather expensive prior art devices.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A device for manipulating particles present in a fluid medium, comprising:
a planar substrate, formed with at least one primary microchannel to allow passage of the fluid medium therethrough, said at least one primary microchannel having walls and a base and being in fluid communication with a plurality of secondary microchannels via at least one branching point; and
at least one ultrasound transmission pair, positioned at opposite sides of said walls to generate ultrasound waves propagating through the fluid medium substantially parallel to said planar substrate such as to form a standing wave defining an ultrasonically active region within said at least one primary microchannel.

2. A method of manipulating particles present in a fluid medium, comprising;
establishing a flow of the fluid medium through at least one primary microchannel formed in a planar substrate, said at least one primary microchannel having walls and a base and being in fluid communication with a plurality of secondary microchannels via at least one branching point; and
generating ultrasound waves propagating through the fluid medium substantially parallel to said planar substrate such as to form a standing wave defining an ultrasonically active region within said at least one primary microchannel;
thereby manipulating the particles in said at least one primary microchannel.

3-4. (canceled)

5. The device of claim 1, wherein the particles are maneuvered within said at least one primary microchannel.

6. The device of claim 1, wherein the particles are separated from the fluid medium.

7. The device of claim 1, wherein the particles are sorted by size, whereby particles of substantially different sizes are manipulated into different secondary microchannels of said plurality of secondary microchannels.

8-21. (canceled)

22. The device of claim 1, wherein said standing wave has a velocity anti-node, located along a substantially central region of said at least one primary microchannel, and velocity nodes, located near or at walls of said at least one primary microchannel, such that the particles are accumulated along said velocity anti-node hence being separated from the fluid flowing at regions other than said central region.

23. The device of claim 22, wherein said at least one primary microchannel has a characteristic width which is about half the wavelength of said standing wave.

24. The device of claim 1, wherein said standing wave has a velocity node located near or at one wall of said at least one primary microchannel and a velocity anti-node located near or at the opposite wall of said at least one primary microchannel, such that the particles are sorted by size, whereby large particles are selectively accumulated along said velocity anti-node hence being separated from the fluid and smaller particles flowing at regions being sufficiently far from said opposite wall.

25. The device of claim 24, wherein said at least one primary microchannel has a characteristic width which is about quarter of the wavelength of said standing wave.

26. The device of claim 1, wherein said at least one branching point comprises a plurality of branching points, and said at least one ultrasound transmission pair comprises a plurality of ultrasound transmission pairs arranged such that each ultrasound transmission pair defines an ultrasonically active region located upstream a respective branching point.

27. The device of claim 1, wherein said at least one branching point comprises a plurality of branching points, and said at least one primary microchannel comprises linear parts and nonlinear parts arranged such that each linear part is located upstream a respective branch point.

28. The device of claim 27, wherein said at least one ultrasound transmission pair comprises a plurality of ultrasound transmission pairs each being aliened substantially parallel to a linear part of said at least one primary microchannel.

29. The device of claim 27, wherein said planar substrate is formed with gaps designed and constructed to acoustically decouple different acoustically active regions in said at least one primary microchannel.

30-32. (canceled)

33. The device of claim 1, wherein at least one of said plurality of secondary microchannels and said at least one primary microchannel comprises an outlet port.

34. The device of claim 1, further comprising a control unit capable of controlling said at least one ultrasound transmission pair to provide ultrasound waves of controlled frequency adapted to the transverse dimensions of said at least one primary microchannel, such as to form said standing wave.

35. The device of claim 34, wherein said control unit is designed and configured to control a phase difference between ultrasound waves generated by a first member of said ultrasound transmission pair and a second member of said ultrasound transmission pair, thereby adjusting the location of nodes and antinodes of said standing wave.

36. The method of claim 2, further comprising adapting the frequency of said ultrasound waves to the transverse dimensions of said at least one primary microchannel, such as to form said standing wave.

37. The method of claim 2, wherein said ultrasound waves are generated from two opposite external sides of said walls and the method further comprises adapting a phase difference between ultrasound waves generated at one external side of said walls and ultrasound waves generated at the opposite external side of said walls, thereby adjusting the location of nodes and antinodes of said standing wave.

38. The device of claim 1, further comprising a flow rate controller configured for providing a predetermined flow rate to said inlet port.

39. (canceled)

40. The method of claim 2, wherein said establishing said flow is at a flow rate selected such that fluid flow within said at least one primary microchannel is characterized by Reynolds number which is below 1.

41. The device of claim 1, wherein the location and size of said ultrasonically active region is selected such that a characteristic diffusion length of the particles within the fluid medium is short compared to a characteristic transverse size of at least one primary microchannel.

42. The device of claim 1, further comprising at least one layer of impedance matching material introduced between said at least one ultrasound transmission pair and said walls.

43-44. (canceled)

45. The method of claim 2, wherein said standing wave has a velocity anti-node, located along a substantially central region of said at least one primary microchannel, and velocity nodes, located near or at walls of said at least one primary microchannel, such that the particles are accumulated along said velocity anti-node hence being separated from the fluid flowing at regions other than said central region.

46. The method of claim 45, wherein said at least one primary microchannel has a characteristic width which is about half the wavelength of said standing wave.

47. The method of claim 2, wherein said standing wave has a velocity node located near or at one wall of said at least one primary microchannel and a velocity anti-node located near or at the opposite wall of said at least one primary microchannel, such that the particles are sorted by size, whereby large particles are selectively accumulated along said velocity anti-node hence being separated from the fluid and smaller particles flowing at regions being sufficiently far from said opposite wall.

48. The method of claim 47, wherein said at least one primary microchannel has a characteristic width which is about quarter of the wavelength of said standing wave.
